(19) United States
(12) Patent Application Publication
(10) Pub. No.: US 2015/0347612 A1
(43) Pub. Date: Dec. 3, 2015

(54) INFORMATION TERMINAL AND CONTROL METHOD

(71) Applicant: CANON KABUSHIKI KAISHA, Tokyo (JP)

(72) Inventor: Tetsuya Matsumoto, Kawasaki-shi (JP)

(21) Appl. No.: 14/723,257

(22) Filed: May 27, 2015

(30) Foreign Application Priority Data
May 30, 2014 (JP) 2014-112625

(51) Int. Cl. G06F 17/30; G06F 17/22

(52) U.S. Cl. CPC G06F 17/30896; G06F 17/30899; G06F 17/2247

(57) ABSTRACT

An information terminal, on which a web browser having a function of storing, for each web application, data specified by a web application accessed by the web browser in a browser storage, operates, includes a determination unit configured to determine a state of a communication of a web application for using the browser storage, and a display control unit configured to display information relating to use of the web application in accordance with determination made by the determination unit.

### BACKGROUND OF THE INVENTION

1. Field of the Invention

The present invention relates to a technique used for providing a web browser implementing functions of data storage in the web browser and an offline web application in HTML5.

2. Description of the Related Art

Various extended functions are provided in HTML5 in association with advance of functions of web applications. For example, an extended function for operating a web application even when a terminal, such as a smartphone or a tablet, is not connected to a network, is available.

More specifically, an Application Cache function is available in which when a website (web application) is accessed, a file, from a network, is cached in a predetermined storage area in an information terminal on which a web browser operates. The predetermined storage area is an area secured to be used by the web browser. Furthermore, web storage or Indexed DB function and the like for storing data, required in accordance with a web application, in the storage area for the web browser, are available. Still furthermore, a File System API function for manipulating a file, in the storage area secured for the web browser, via the web browser is also available. Data stored with the functions described above is stored in an area for each web application provided for each origin as a combination of a protocol, a host name, and a port. The storage area, in which data is stored using the functions such as Application Cache, web storage, Indexed DB, and File System API, is hereinafter referred to as a browser storage.

The extended functions further include a Web workers function with which the processing that takes time to be completed is executed in a background. The extended functions further include a function of notifying a connection state of an information processing terminal, on which the web browser operates, to a network. With the function, a web application can refer to an online state indicating that the terminal is connected to the network and an offline state indicating that the terminal is not connected to the network, and when the state changes, the web application is notified of the change.

Japanese Patent Application Laid-Open No. 2013-41374 discusses a conventional technique relating to an electronic device capable of notifying a user of start and progress of download of a content file via a network in the background.

To operate the web application in the offline state, the data storage in the browser storage needs to be completed before the terminal transitions to the offline state. Data with a larger capacity can be stored in the browser storage, compared with a cache function managed by a conventional web browser. However, it takes time to store the data with a large capacity in the browser storage. Thus, processing of storing data in the browser storage may be executed as background processing in a thread different from that for displaying a web page, as in the conventional technique described above.

As described above, processing of storing data in the browser storage of the web browser is executed based on an instruction from a web application. Preferably, the user is appropriately notified of the progress and the like of the processing of storing data in the browser storage. However, Japanese Patent Application Laid-Open No. 2013-41374 only discusses a function of notifying the user of the start and the progress of the background processing executed by the electronic device. More specifically, the data manipulation to the browser storage is executed based on an instruction from the web application, and thus this conventional technique cannot provide a system capable of appropriately issuing notification.

### SUMMARY OF THE INVENTION

The present invention is directed to an information terminal capable of appropriately notifying a state of processing such as data storage processing and synchronization processing in a browser storage of a web browser.

According to an aspect of the present invention, an information terminal, on which a web browser having a function of storing, for each web application, data specified by a web application accessed by the web browser in a browser storage, operates, includes a determination unit configured to determine a state of a communication of a web application for using the browser storage, and a display control unit configured to display information relating to use of the web application in accordance with determination made by the determination unit.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration according to an exemplary embodiment of the present invention.

FIG. 2 is a block diagram illustrating an example of a functional configuration of a web browser.

FIG. 3 is a block diagram illustrating an example of a hardware configuration of an information terminal.

FIG. 4 is a block diagram illustrating an example of a hardware configuration of an information terminal.

FIG. 5 is a diagram illustrating an example of a website access status information table managed by the web browser.

FIG. 6 is a diagram illustrating an example of a display screen displaying an access status of a website to a browser storage, provided by the web browser.

FIG. 7 is a flowchart illustrating an example of a procedure of processing executed when a change notification is received from a web application.

FIG. 8 is a flowchart illustrating an example of a procedure of processing executed when access to the browser storage starts.

FIG. 9 is a flowchart illustrating an example of a procedure of processing executed when access to the browser storage ends.

FIG. 10 is a flowchart illustrating an example of a procedure of processing executed when a closing instruction to the web browser is detected.

FIG. 11 is a diagram illustrating an example of setting screen related to access processing to the browser storage.

FIG. 12 is a flowchart illustrating processing of determining whether to continue the access processing to the browser storage.

FIG. 13 is a diagram illustrating an example of a determination screen for determining whether the access processing needs to be continued.

FIG. 14 is a flowchart illustrating an example of a procedure of processing executed when transition to an offline state is detected.

FIG. 15 is a flowchart illustrating a procedure of processing executed when access to the browser storage starts.

FIG. 16 is a diagram illustrating an example of a warning screen in the offline state.

FIG. 17 is a flowchart illustrating a procedure of processing executed when access to the browser storage starts according to a second exemplary embodiment.

FIG. 18 is a flowchart illustrating an example of a procedure of processing executed when access to the browser storage ends according to the second exemplary embodiment.

### DESCRIPTION OF THE EMBODIMENTS

Exemplary embodiments of the present invention are described below with reference to the drawings.

### <Description of System Configuration>

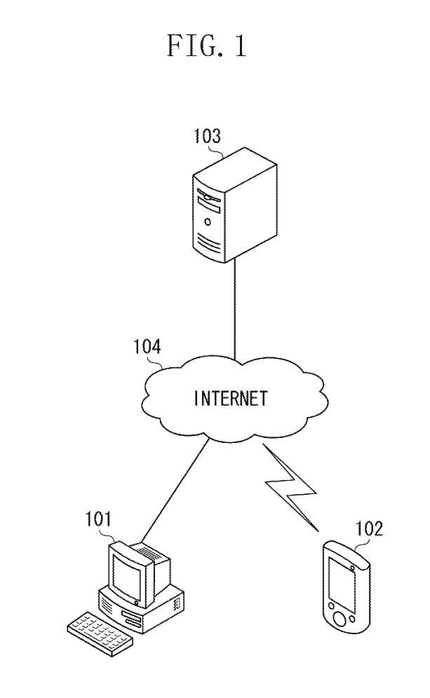

FIG. 1 is a schematic diagram illustrating an example of a system configuration according to a first exemplary embodiment of the present invention.

In FIG. 1, an information terminal 101 such as a personal computer (PC), and an information terminal 102 such as a smartphone. A web server 103 provides a webpage to the information terminals 101 and 102. The information terminals 101 and 102 and the web server 103 are mutually communicably connected to each other via a known technique such as the Internet 104. The information terminal 102 can perform wireless communications. Although not illustrated in the figure, there can be additional information terminals 101 and 102. The information terminal, to which the present exemplary embodiment can be applied, includes various devices such as a tablet computer, a car navigation system, and a digital television receiver.

### <Functional Configuration of Web Browser>

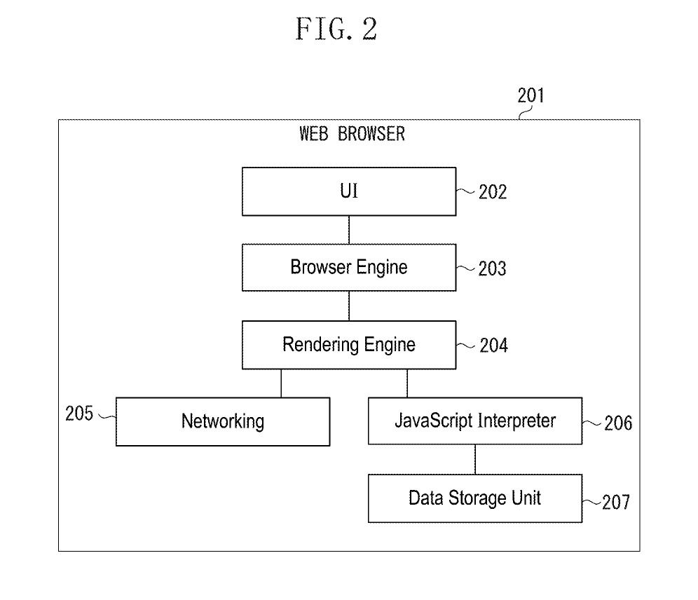

FIG. 2 is a block diagram illustrating an example of a functional configuration of a web browser 201 that can operate on the information terminals 101 and 102 illustrated in FIG. 1.

A user interface (UI) 202 includes an address bar, backward and forward buttons, and a setting screen of the web browser 201, and is an entire area other than a window in which a webpage is displayed. A browser engine 203 executes processing between the UI 202 and a rendering engine 204. The rendering engine 204 displays a requested content using, for example, HyperText Markup Language (HTML). A networking 205 calls a network with an HTTP request and the like. A JavaScript (registered trademark) interpreter 206 analyzes and executes a JavaScript (registered trademark) code. The web browser 201 generates and executes an instance of the JavaScript (registered trademark) interpreter 206 (hereinafter, also referred to as an interpreter), whereby processing according to the present exemplary embodiment described below is executed. Alternatively, the processing according to the present exemplary embodiment described below may be implemented in other ways as long as the processing is provided as a function of the web browser 201.

A data storage unit 207 stores data, to be stored with a functions such as cookie, or Application Cache, web storage, Indexed DB, and File System API in HTML5, in a hard disk drive (HDD) 311 or a flash solid state drive (SSD) 404. In the present exemplary embodiment, an area to be stored in the data storage unit 207 is referred to as a browser storage. The browser storage is secured, in the information terminals 101 and 102, for each web browser 201 that operates on the information terminals 101 and 102. A manipulation of storing data in the browser storage is performed with JavaScript (registered trademark), for example.

### <Hardware Configuration of Information Terminal 101>

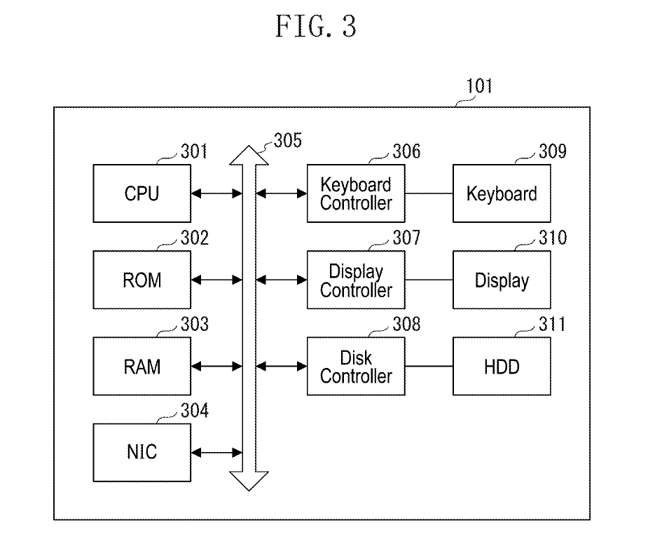

FIG. 3 is a block diagram illustrating an example of a hardware configuration of the information terminal 101 on which the web browser 201 can operate.

The information terminal 101 includes a central processing unit (CPU) 301 that executes software stored in a read only memory (ROM) 302 or the hard disk drive (HDD) 311 serving as a storage device. The CPU 301 performs overall control of hardware units connected to a system bus 305. A random access memory (RAM) 303 functions as a main memory, a work area, or the like for the CPU 201. A network interface card (NIC) 304 transmits and receives data to and from other nodes. A keyboard controller 306 controls an instruction input from a keyboard 309 of a PC. A display controller 307 controls a display on a display module 310 including a liquid crystal display for example. A disk controller 308 controls the HDD 311 (i.e., a large capacity storage device).

### <Hardware Configuration of Information Terminal 102>

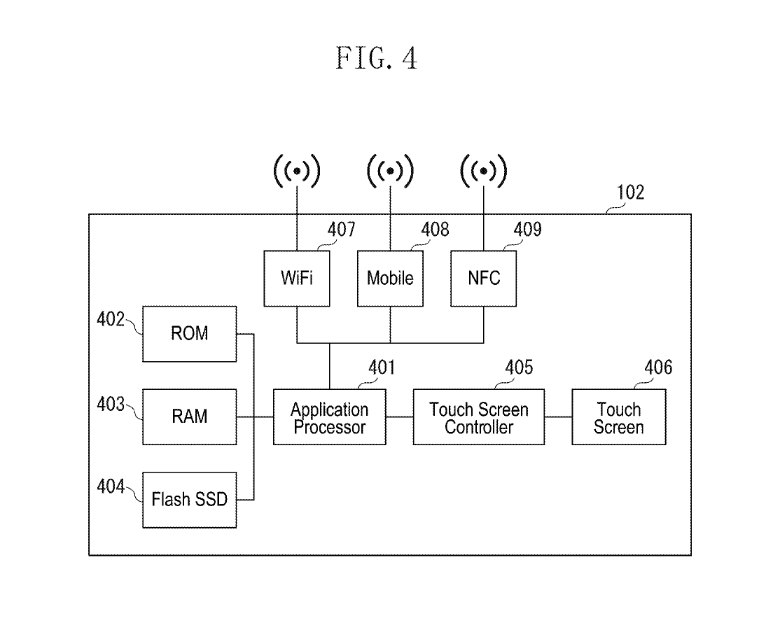

FIG. 4 is a block diagram illustrating an example of a hardware configuration of the information terminal 102 on which the web browser 201 can operate.

The information terminal 102 includes an application processor (hereinafter, referred to as AP) 401 that executes software stored in a ROM 402 or the flash SSD 404. The AP 401 performs overall control on connected hardware units. A RAM 403 functions as a main memory, a work area, or the like for the AP 401. The flash SSD 404, which is a storage device, stores an operating system, various applications such as the web browser, database data, user files, and the like. A touch screen controller 405 controls a touch screen (display module) 406 connected to the touch screen controller 405. A wireless local area network (LAN) control unit 407, a mobile communication control unit 408, and a near field communication control unit 409 respectively control wireless LAN communications, mobile communications, and near field communications.

### <Website Access Status Information Table>

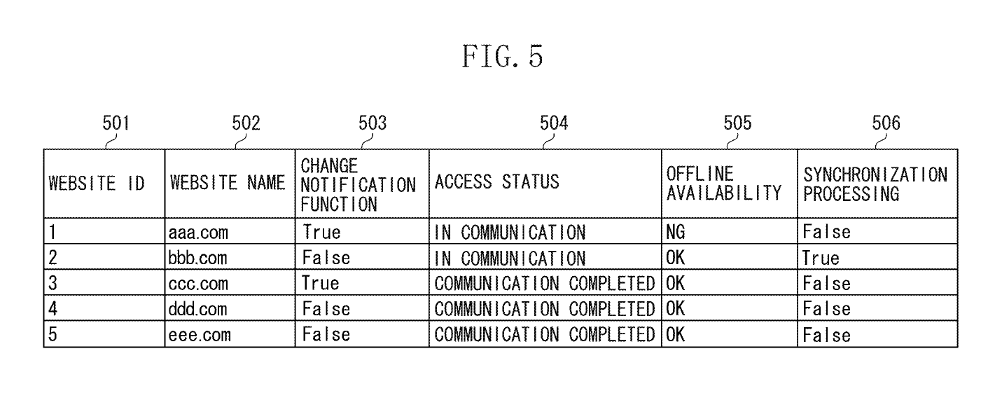

FIG. 5 is a diagram illustrating an example of a website access status information table managed by the web browser 201. The figure illustrates access status information of the web application to the browser storage.

Herein, the access status indicates whether the web application (website) is accessing the browser storage. Types of the access status include “in communication” indicating that the web application is accessing the browser storage, and “communication completed” indicating that the web application is not accessing the browser storage.

The present exemplary embodiment is further characterized in that, when the web application (website) accesses the browser storage, the web application (website) issues a notification to the web browser 201. The notification related to the change of the access status is referred to as a change notification. This function of the web application is referred to as a change notification function. In the present exemplary embodiment, an environment including both a web application having the change notification function and a web application not having the change notification function, is also described.

In FIG. 5, a column 501 indicates a website ID as an ID for uniquely identifying a website in a system constructed by the web browser 201. In the present exemplary embodiment, websites are distinguished from each other with a method of distinguishing an origin area. Origin is a combination of pieces of information such as a protocol, a host name, and a port. In the browser storage, a predetermined area is allocated to each origin of the web application, and data is processed in accordance with an instruction from the web application. In the table in FIG. 5, a record is added when a website has used the browser storage.

A column 502 indicates a website name as a name of a website. In the present exemplary embodiment, a host name is the website name. A column 503 indicates whether a website has the change notification function described above. “True” is set to a website having the change notification function and “False”, which is the default, is set to a website not having the change notification function. A column 504 indicates an access status to the browser storage described above. How the item in the column 504 is set is described below.

A column 505 indicates offline availability information of a website. “OK” is set to a website that can be used offline, and “NG” is set to a website that cannot be used offline. How the item in the column 505 is set is described below.

A column 506 indicates synchronization processing information. “True” is set when the browser storage is accessed for the synchronization processing, and “False” is set when the browser storage is accessed not for the synchronization processing but for normal processing such as storing of data. How the item in the column 506 is set is described below.

### <Example of Screen for Displaying Access Status of Website>

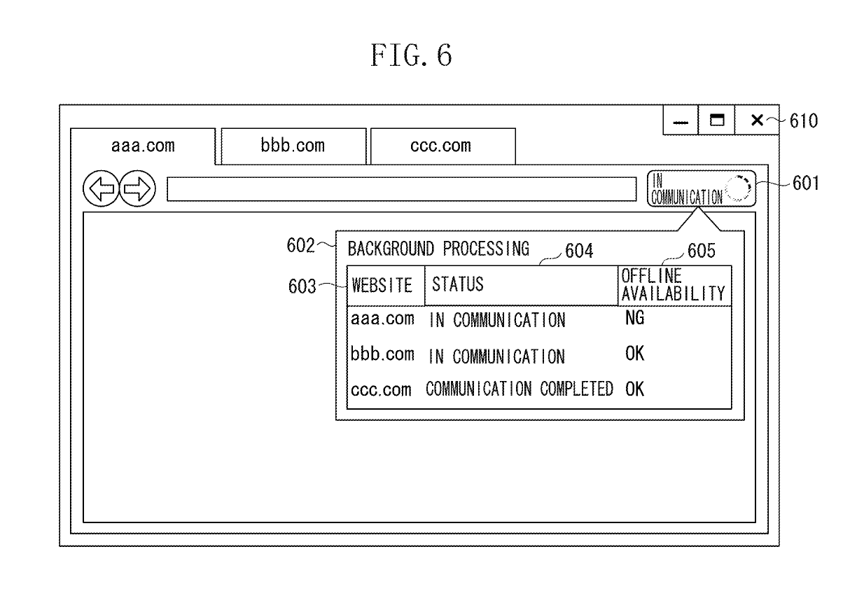

FIG. 6 illustrates an example of a typical display control according to the present exemplary embodiment, and is a diagram illustrating a screen displaying the access status of a website to the browser storage. The screen is obtained by adding a display for referring to the website access status information table illustrated in FIG. 5 to a screen for browsing provided by the web browser 201. This additional screen is periodically updated by referring to the website access status information table.

An area 601 represents an example of the access status of the website to the browser storage. Herein, the access status of the website “aaa.com” corresponding to the currently effective tab is “in communication” with reference to the table illustrated in FIG. 5.

A list 602 is an example list of access statuses of the websites using the browser storage, to the browser storage. The list 602 is displayed when the area 601 is clicked. In the list 602, a website name 603, an access status 604, and offline availability information 605 are displayed for each website. These pieces of information are displayed by referring to the website name 502, the access status 504, and the offline availability information 505 in the website access status information table illustrated in FIG. 5.

For example, a user using an information terminal, on which the web browser 201 is operating, can know that the website can be used even when the information terminal transitions to an offline state when the offline availability information 605 is “OK”. Thus, the user can check the display, and then start to move to a location with no network connection and use the website with the web browser 201 at the location. Furthermore, the user can browse the website with the web browser 201, while turning off wireless LAN communication functions of the information terminal such as Wireless Fidelity (Wi-Fi) as appropriate for saving power.

A close button 610 is used for closing the web browser 201.

<Processing of Receiving Change Notification from Web Application>

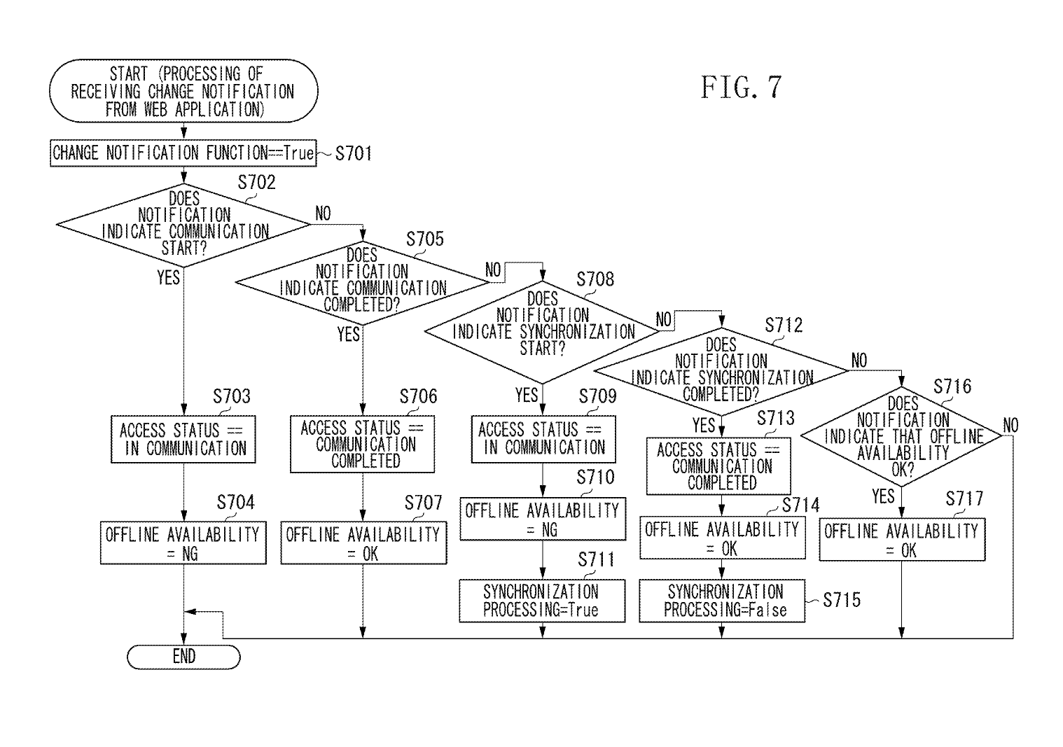

FIG. 7 is a flowchart illustrating processing executed when the change notification is received by the web browser 201 from the web application (website). In this processing, the information in the website access status information table illustrated in FIG. 5 is updated for the website, which is the web application having the change notification function. The web browser 201 generates an instance of the JavaScript (registered trademark) interpreter 206, (hereinafter, referred to as an interpreter), and executes this processing.

In the present exemplary embodiment, the web application (website) having the change notification function transmits the change notification when the web application (website) accesses the browser storage for storing data. The change notification is transmitted with the JavaScript (registered trademark) included in the web application, as in the case of processing of storing data in the browser storage. Types of the change notification include “communication start”, “communication completed”, and “offline availability OK”. The “communication start” is a notification transmitted when the storing of data in the browser storage starts. The “communication completed” is a notification transmitted when the storing of data in the browser storage is completed. The “offline availability OK” is a notification transmitted when storing of data, for using the web application in the offline state, in the browser storage is completed. The types of notification may further include “synchronization start” and “synchronization completed”. The “synchronization start” is a notification transmitted when processing of synchronizing data in the browser storage with the data in the web server starts. The “synchronization completed” is a notification transmitted when the processing of synchronizing the data in the browser storage with the data in the web server is completed. Generally, the storing of data in the browser storage and synchronizing of data is executed in response to an instruction from the website, and thus the web browser 201 cannot know when the processing has started or ended. However, with the change notification from the web browser, the web browser 201 can know when the processing has started or ended.

When this processing starts, in step S701, the interpreter 206 sets the change notification function 503 of the website as the notification source to “True”. In step S702, the interpreter 206 determines whether the received change notification is the “communication start”. When the interpreter 206 determines that the received notification is the “communication start” (YES in step S702), the processing proceeds to step S703. On the other hand, when the interpreter 206 determines that the received notification is not the “communication start” (NO in step S702), the processing proceeds to step S705.

In step S703, the interpreter 206 sets the access status 504 of the website as the notification source to “in communication”. Then, in step S704, the interpreter 206 sets the offline availability information 505 of the website as the notification source to “NG”, and the processing is terminated.

In step S705, the interpreter 206 determines whether the received change notification is the “communication completed”. When the interpreter 206 determines that the received notification is the “communication completed” (YES in step S705), the processing proceeds to step S706. On the other hand, when the interpreter 206 determines that the received notification is not the “communication completed” (NO in step S705), the processing proceeds to step S708.

In step S706, the interpreter 206 sets the access status 504 of the website as the notification source to “communication completed”. Then, in step S707, the interpreter 206 sets the offline availability information 505 of the website as the notification source to “OK”, and the processing is completed.

In step S708, the interpreter 206 determines whether the received change notification is the “synchronization start”. When the interpreter 206 determines that the received notification is the “synchronization start” (YES in step S708), the processing proceeds to step S709. On the other hand, when the interpreter 206 determines that the received notification is not the “synchronization start” (NO in step S708), the processing proceeds to step S712.

In step S709, the interpreter 206 sets the access status 504 of the website as the notification source to “in communication”. Then, in step S710, the interpreter 206 sets the offline availability information 505 of the website as the notification source to “NG”. Then, in step S711, the interpreter 206 sets the synchronization processing information 506 of the website as the notification source to “True”, and the processing is terminated.

In step S712, the interpreter 206 determines whether the received change notification is the “synchronization completed”. When the interpreter 206 determines that the received notification is the “synchronization completed” (YES in step S712), the processing proceeds to step S713. On the other hand, when the interpreter 206 determines that the received notification is not the “synchronization completed” (NO in step S712), the processing proceeds to step S716.

In step S713, the interpreter 206 sets the access status 504 of the website as the notification source to “communication completed”. Then, in step S714, the interpreter 206 sets the offline availability information 505 of the website as the notification source to “OK”. Then, in step S715, the interpreter 206 sets the synchronization processing information 506 of the website as the notification source to “False”, and the processing is terminated.

In step S716, the interpreter 206 determines whether the received change notification is the “offline availability OK”. When the interpreter 206 determines that the received change notification is the “offline availability OK” (YES in step S716), the processing proceeds to step S717. On the other hand, when the interpreter 206 determines that the received change notification is not the “offline availability OK” (NO in step S716), the processing is terminated. Then, in step S717, the interpreter 206 sets the offline availability information 505 of the website as the notification source to “OK”, and the processing is terminated.

<Processing Executed when Access to Browser Storage Starts>

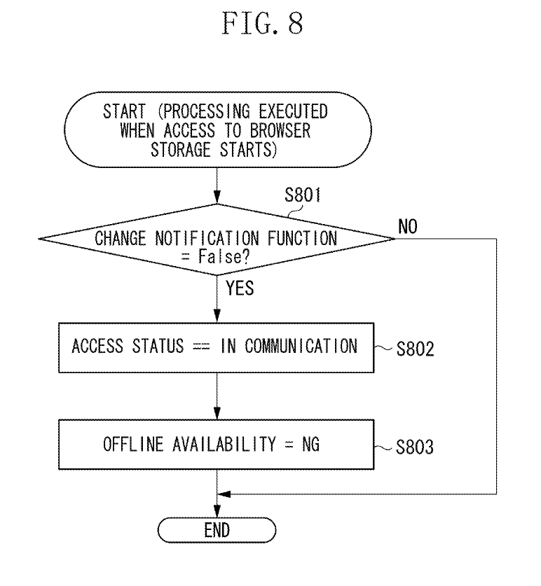

FIG. 8 is a flowchart illustrating processing executed when access to the browser storage starts. In this processing, the information in the website access status information table illustrated in FIG. 5 is updated for the website not having the change notification function. The web browser 201 detects that the access has started, when access to the browser storage by a website as a new entry in the table illustrated in FIG. 5 or by website that has been in the “communication completed” state is detected. The web browser 201 generates an instance of the interpreter 206 and executes this processing.

When the access to the browser storage starts, in step S801, the interpreter 206 determines whether the change notification function 503 of the website as an access origin is “False” (whether the website has the change notification function). When the interpreter 206 determines that the change notification function 503 is “False” (YES in step S801), the processing proceeds to step S802. On the other hand, when the interpreter 206 determines that the change notification function 503 is not “False” (NO in step S801), the processing is terminated.

In step S802, the interpreter 206 sets the access status 504 of the website as the access origin to “in communication”. Then, in step S803, the interpreter 206 sets the offline availability information 505 of the website as the access origin to “NG” and the processing is terminated. In other words, when the website not having the change notification function accesses the browser storage, it is determined that the website is in the “in communication” state and cannot be used offline.

<Processing Executed when Access to Browser Storage Ends>

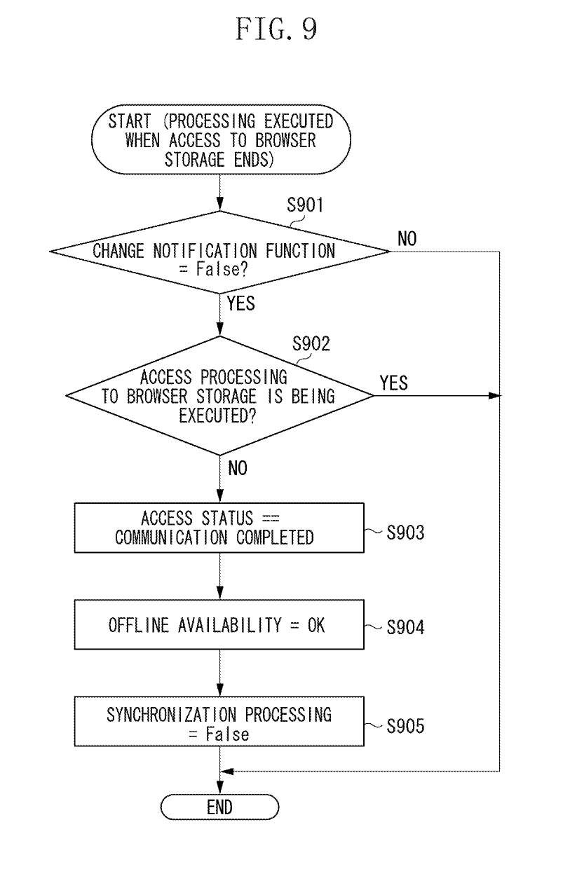

FIG. 9 is a flowchart illustrating processing executed by the web browser 201 when access to the browser storage ends. This processing is processing executed when the access to the browser storage in FIG. 8 ends. In this processing, the information in the website access status information table illustrated in FIG. 5 is updated for the website not having the change notification function. The web browser 201 generates an instance of the interpreter 206 and executes this processing.

In step S901, the interpreter 206 determines whether the change notification function 503 of the website as the access origin is “False” (whether the website has the change notification function). When the interpreter 206 determines that the change notification function 503 is “False” (YES in step S901), the processing proceeds to step S902. On the other hand, when the interpreter 206 determines that the change notification function 503 is not “False” (NO in step S901), the processing is terminated.

In step S902, the interpreter 206 determines whether the website as the access origin is performing the access processing to the browser storage. This determination is made to confirm that there is no on-going access processing involving data of a type different from the data using the browser storage, for which this processing has started. More specifically, the result in step S902 is YES, when the access processing to the browser storage related to the web storage is terminated but access processing to a browser storage related to Indexed DB and the like other than the web storage has not been terminated. When the interpreter 206 determines that the website as the access origin is not performing the access processing to the browser storage (NO in step S903), the processing proceeds to step S903. On the other hand, when the interpreter 206 determines that the website as the access origin is performing the access processing to the browser storage (YES in step S903), the processing is terminated.

In step S903, the interpreter 206 sets the access status 504 of the website as the access origin to “communication completed”. Then, in step S904, the interpreter 206 sets the offline availability information 505 of the website as the access origin to “OK”. In other words, when the website not having the change notification function does not access the browser storage, it is determined that the website is in the “communication completed” state and is available off line. Then, in step S905, the interpreter 206 sets the synchronization processing information of the website as the access origin to “False”, and the processing is terminated.

<Processing Executed when Closing Instruction to Web Browser is Detected>

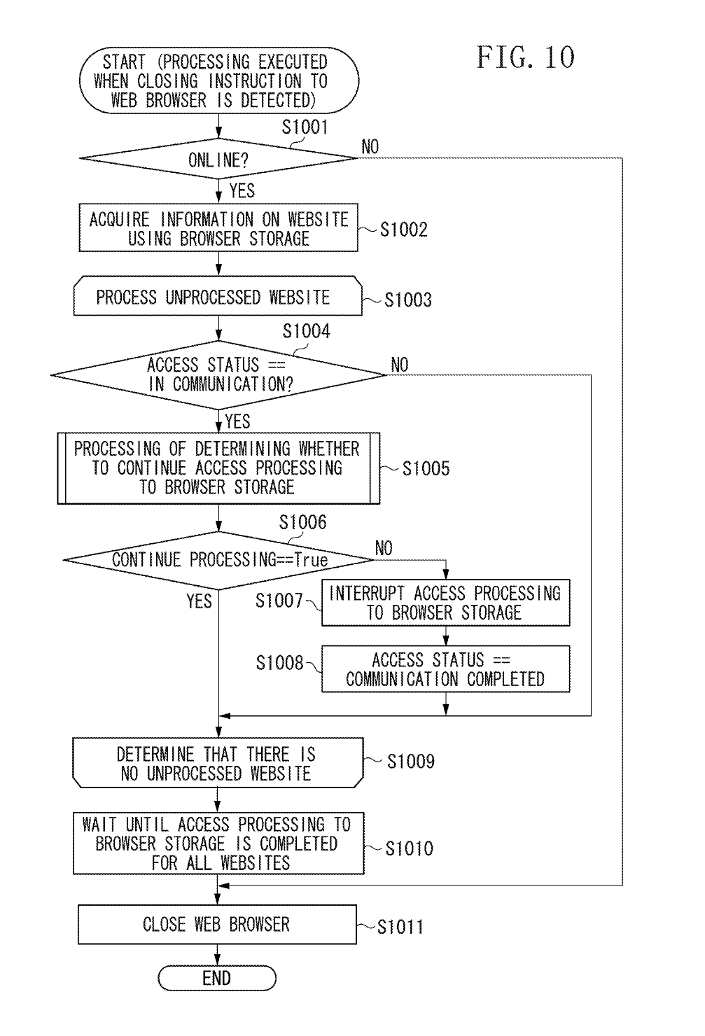

FIG. 10 is a flowchart illustrating processing executed when a closing instruction is issued to the web browser 201 from the user and the like. The closing instruction to the web browser is issued when the user presses the closing button 610 in FIG. 6. The web browser 201 generates an instance of the interpreter 206 and executes this processing.

In this processing, whether the access processing to the browser storage continues when the web browser is closed is determined for the website executing the access processing to the browser storage. When it is determined that the access processing continues, the web browser is closed after the access processing is completed. In this case, the screen illustrated in FIG. 6 provided by the web browser on the display module of the information terminal may be closed. On the other hand, when it is determined that the access processing does not continue, the access processing is interrupted.

When the closing instruction is issued to the web browser 201, in step S1001, the interpreter 206 determines whether the network is in the online state. When the interpreter 206 determines that the network is in the online state (YES in step S1001), the processing proceeds to step S1002. On the other hand, when the interpreter 206 determines that the network is not in the online state and thus is in the offline state (NO in step S1001), the processing proceeds to step S1011.

In step S1002, the interpreter 206 acquires information on the website using the browser storage from the website access status information table illustrated in FIG. 5. Then, processing in steps S1003 to S1009 is repeated on websites, for which the information is obtained in step S1002, as processing targets.

In step S1004, the interpreter 206 determines whether the access status 504, in the information on the website as the processing target, is “in communication”. When the interpreter 206 determines that the access status 504 is “in communication” (YES in step S1004), the processing proceeds to step S1005. On the other hand, when the interpreter 206 determines that the access status 504 is not “in communication” (NO in step S1004), the processing proceeds to step S1009.

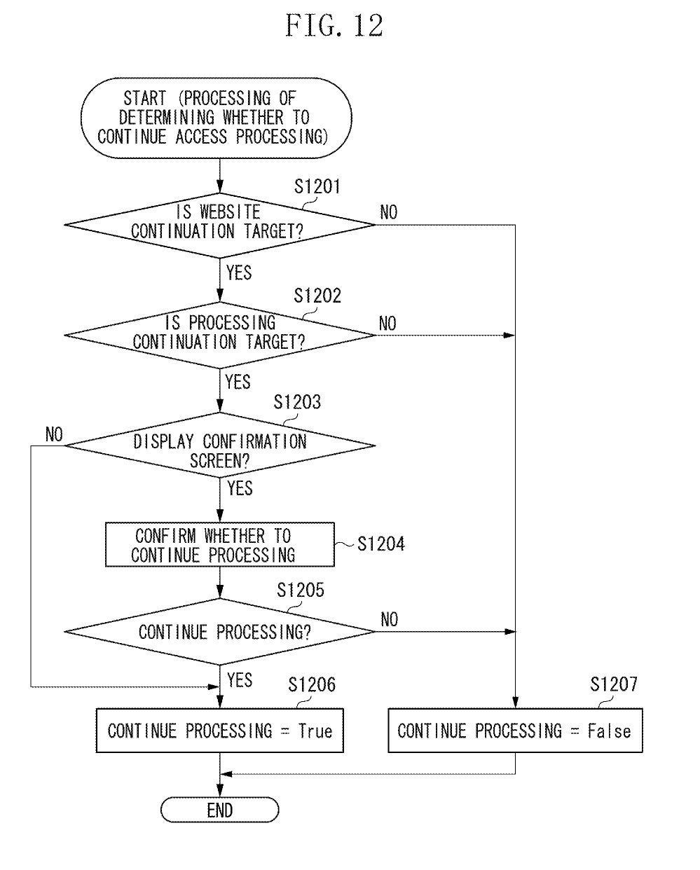

In step S1005, the interpreter 206 executes processing of determining whether the access processing to the browser storage continues. The processing of determining whether to continue the access processing to the browser storage is described below in detail with reference to FIG. 12. In step S1006, the interpreter 206 determines whether the access processing of the website as the processing target is determined to be continued in step S1005 (whether a variable indicating whether the processing needs to be continued is “True”). When the interpreter 206 determines that the variable indicates that the processing needs to be continued (True) (YES in step S1006), the processing proceeds to step S1009. On the other hand, when the interpreter 206 determines that the processing is determined not to be continued (NO in step S1006), the processing proceeds to step S1007.

In step S1007, the interpreter 206 interrupts the access processing of the website as the processing target to the browser storage. Then, in step S1008, the interpreter 206 sets the access status 504 of the website as the processing target to “communication completed”.

In step S1009, the interpreter 206 determines whether there is a website that has not been subjected to the processing in steps S1003 to S1008. When the interpreter 206 determines that there is no website that has not been subjected to the processing in steps S1003 to S1008, the processing proceeds to step S1010.

In step S1010, the interpreter 206 waits until the access processing of all the websites, for which the access processing has been determined to be continued, is completed. Then, in step S1011, the interpreter 206 closes the web browser, and the processing is terminated.

### <Example of Setting Screen for Access Processing to Browser Storage>

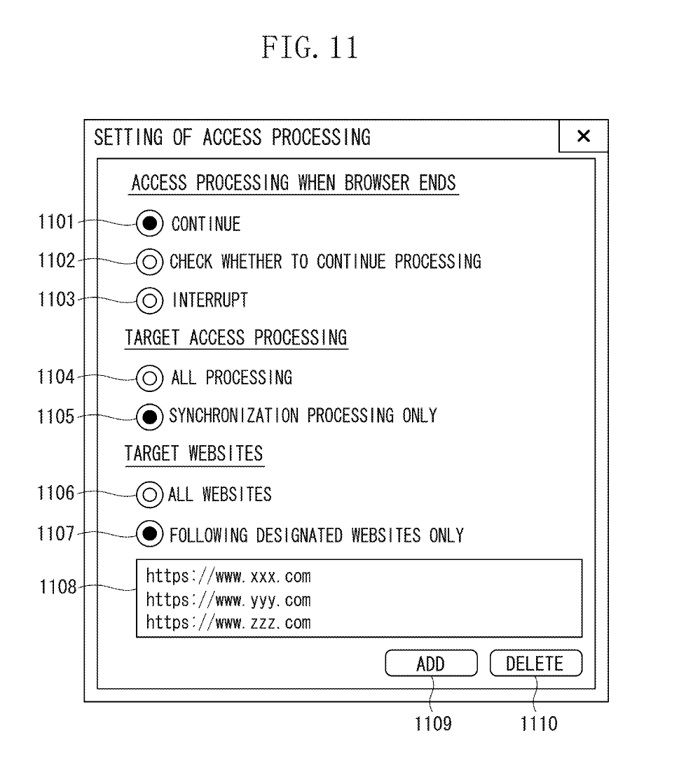

FIG. 11 is a diagram illustrating an example of setting screen related to the access processing to the browser storage in the web browser 201. The user can set how the access processing to the browser storage is controlled when the web browser 201 is closed, via the screen. In steps S1005, determination of whether to continue the access processing to the browser storage is made based on the settings in the screen.

Radio buttons 1101, 1102, and 1103 are used for setting to determine whether to continue the access processing to the browser storage when the web browser 201 is closed. When the radio button 1101 is selected, the access processing to the browser storage continues when the web browser 201 is closed. When the radio button 1102 is selected, a screen that prompts the user to select whether to continue the access processing to the browser storage when the web browser 201 is closed is additionally displayed for each time. When the radio button 1103 is selected, the access processing to the browser storage is not continued but is interrupted when the web browser 201 is closed.

Radio buttons 1104 and 1105 are used to set the detail of the access processing to the browser storage to be continued when the web browser 201 is closed. When the radio button 1104 is selected, all types of the access processing to the browser storage continue. When the radio button 1105 is selected, only the synchronization processing of data in the browser storage with the data in the web server continues.

Radio buttons 1106 and 1107 are used to designate the websites to which the setting in the screen is applied. When the radio button 1106 is selected, control based on the settings in the screen described above is performed on all the websites. When the radio button 1107 is selected, the control based on the settings in the screen described above is performed only on the websites with the URL designated in a URL list 1108. An add button 1109 is used for adding an URL to the URL list 1108. When the add button 1109 is pressed, a screen for inputting a URL is displayed, and the URL input in the screen is added to the URL list 1108. The input screen may be displayed in a state where the URL of the website currently displayed by the web browser 201 (with the effective tab) is input. A delete button 1110 is used for deleting a URL in the URL list 1108. When the delete button 1110 is pressed, a URL selected in the URL list 1108 is deleted.

In the present exemplary embodiment, the example where the setting of the access processing to the browser storage is performed via the setting screen is described. Alternatively, the web browser 201 may hold the settings in advance.

### <Processing to Determine Whether to Continue Access Processing to Browser Storage>

FIG. 12 is a flowchart illustrating processing of determining whether to continue the access processing to the browser storage, executed in step S1005 in FIG. 10, in detail. In this processing, whether to continue the access processing to the browser storage is determined based on the settings on the setting screen, for the access processing to the browser storage, illustrated in FIG. 11.

In step S1201, the interpreter 206 determines whether the website, as the processing target, has been set as an access processing continuation target, based on the settings 1106 to 1108 in FIG. 11. When the radio button 1103 in FIG. 11 is selected, the website is determined not to be the access processing continuation target, regardless of the settings 1106 to 1108. When the interpreter 206 determines that the website, as the processing target, is the continuation target (YES in step S1201), the processing proceeds to step S1202. On the other hand, when the interpreter 206 determines that the website is not the continuation target (NO in step S1201), the processing proceeds to step S1207.

In step S1202, the interpreter 206 determines whether the access processing executed by the website as the processing target is processing as the continuation target, based on the settings 1104 and 1105 in FIG. 11. Whether the access processing under execution is synchronization processing is determined based on the synchronization processing information 506 on the website as the processing target. When the synchronization processing information 506 on the website as the processing target is “True”, the interpreter 206 determines that the access processing under execution is the synchronization processing. When the synchronization processing information 506 on the website as the processing target is “False”, the interpreter 206 determines that the access processing under execution is not the synchronization processing. When the interpreter 206 determines that the access processing under execution is the processing as the continuation target (YES in step S1202), the processing proceeds to step S1203. On the other hand, when the interpreter 206 determines that the access processing under execution is not the processing as the continuation target (NO in step S1202), the processing proceeds to step S1207.

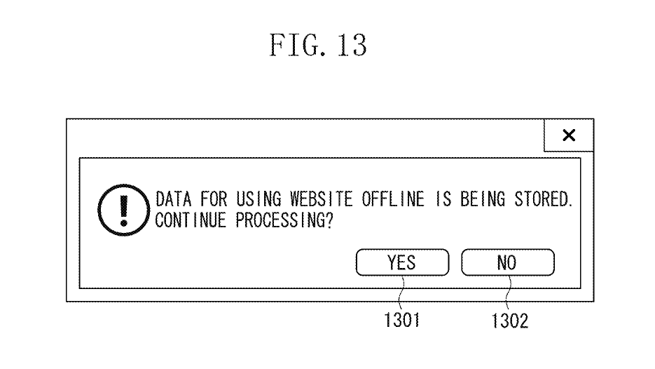

In step S1203, the interpreter 206 determines whether to display a confirmation screen. The confirmation screen is used for confirming whether to continue the access processing. The confirmation screen is determined to be displayed when the radio button 1102 in FIG. 11 is selected. When the interpreter 206 determines to display the confirmation screen (YES in step S1203), the processing proceeds to step S1204. On the other hand, when the interpreter 206 determines not to display the confirmation screen (NO in step S1203, the processing proceeds to step S1206. In step S1204, the interpreter 206 displays a confirmation screen in FIG. 13. FIG. 13 is a diagram illustrating an example of the confirmation screen for confirming whether to continue the access processing to the browser storage. It is determined that continuation of the access processing is selected when a button 1301 is pressed in the confirmation screen in FIG. 13. On the other hand, it is determined that continuation of the access processing is not selected when a button 1302 is pressed. In step S1205, the interpreter 206 determines whether to continue the access processing based on the selection made on the confirmation screen in FIG. 13. When continuation of the access processing is selected (YES in step S1205), the processing proceeds to step S1206. On the other hand, when continuation of the access processing is not selected (NO in step S1205), the processing proceeds to step S1207.

In step S1206, the interpreter 206 sets a variable indicating whether the processing needs to be continued to “True”, and the processing is terminated. On the other hand, the interpreter 206 sets the variable indicating whether the processing needs to be continued to “False”, and the processing is terminated.

<Processing Executed when Transition to Offline State is Detected>

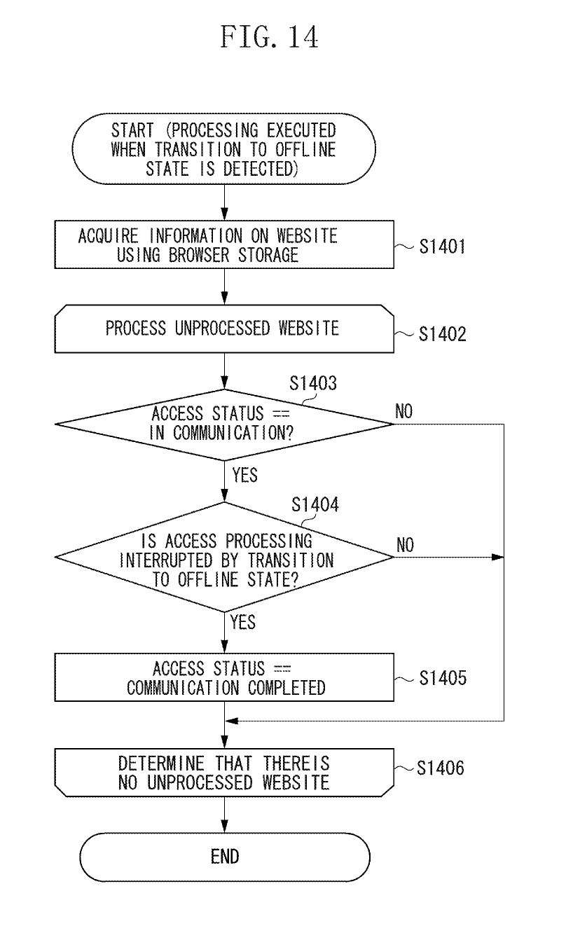

FIG. 14 is a flowchart illustrating processing executed by the web browser 201, when change in a connection state to the network of the information terminal from an online state to an offline state is detected. The web browser 201 generates an instance of the interpreter 206, and executes the processing.

In step S1401, the interpreter 206 acquires information on the website using the browser storage from the website access status information table illustrated in FIG. 5. The interpreter 206 repeats processing in steps S1402 to S1406 on each website, for which the information is acquired in step S1401, as the processing target.

In step S1403, the interpreter 206 determines whether the access status 504 in the information on the website as the processing target is “in communication”. When the interpreter 206 determines that the access status 504 is “in communication” (YES in step S1404), the processing proceeds to step S1404. On the other hand, when the interpreter 206 determines that the access status 504 is not “in communication” (NO in step S1404), the processing proceeds to step S1406. In step S1404, the interpreter 206 determines whether the access processing of the website as the processing target to the browser storage is interrupted because the connection state to the network transitions to the offline state. The processing proceeds to step S1405, when the interpreter 206 determines that the access processing to the browser storage is interrupted (YES in step S1404). On the other hand, when the interpreter 206 determines that the access processing to the browser storage is not interrupted (NO in step S1404), the processing proceeds to step S1406. In step S1405, the interpreter 206 updates the access status 504 of the website as the processing target to be “communication completed”.

In step S1406, when the interpreter 206 determines that there is no website that has not been subjected to the processing in steps S1402 to S1405, the processing is terminated.

<Processing Executed when Website is Started to be Used Offline>

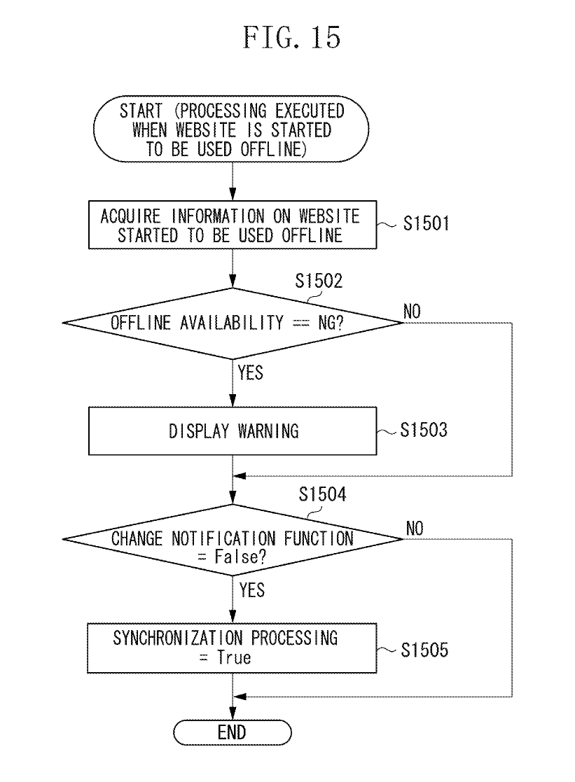

FIG. 15 is a flowchart illustrating processing executed by the web browser 201, upon detecting that the web application (website) is started to be used with the connection state of the information terminal to the network being the offline state. The web browser 201 generates an instance of the interpreter 206 and executes this processing.

When the access processing to the browser storage is interrupted because of the closing of the web browser or the transition to the offline state, the browser storage may not be properly used in the offline state. This processing is for displaying a warning when the web application may not be properly used in the offline state.

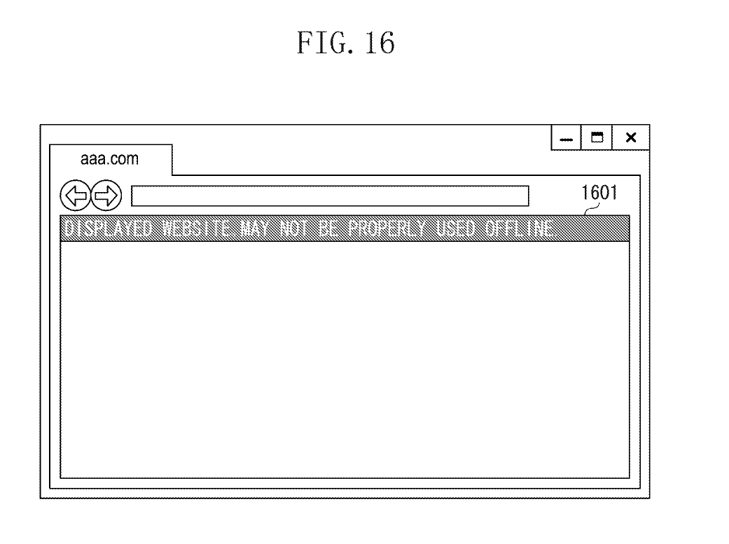

In step S1501, the interpreter 206 acquires information on the website started to be used offline from the website access status information table illustrated in FIG. 5. In step S1502, the interpreter 206 determines whether the offline availability information 505 in the website information acquired in step S1501 is “NG”. When the interpreter 206 determines that the offline availability information 505 is “NG” (YES in step S1502), the processing proceeds to step S1503. On the other hand, when the interpreter 206 determines that the offline availability information 505 is not “NG” (NO in step S1502), the processing proceeds to step S1504. In step S1503, the interpreter 206 displays a warning 1601 illustrated in FIG. 16 to notify the user that the web application may not be properly used in the offline state. FIG. 16 illustrates an example of a screen for warning that the web application may not be properly used in the offline state, displayed on the screen provided by the web browser 201.

In step S1504, the interpreter 206 determines whether the change notification function 503 in the information on the website acquired in step S1501 is “False” (whether the website has the change notification function). When the interpreter 206 determines that the change notification function 503 is “False” (YES in step S1504), the processing proceeds to step S1505. On the other hand, when the interpreter 206 determines that the change notification function 503 is not “False” (NO in step S1504), the processing is terminated. Then, in step S1505, the interpreter 206 sets the synchronization processing information 506 on the website acquired in step S1501 to “True”, and the processing is terminated.

This processing is executed when the web application (website) is used in the offline state and the data in the browser storage is processed. The access processing to the browser storage, executed when the transition to the online state occurs after this data processing, is likely to be the synchronization processing with the web server providing the web application. Thus, in the processing, information for determining that the access processing to the browser storage after the transition to the online state is the synchronization processing when the web application does not have the change notification function, is set in step S1505.

<Notification Processing Executed when Synchronization Processing is Completed>

When the connection state transitions from the offline state to the online state, the user can confirm whether the communication for the synchronization processing is in progress or completed for each web application (website), by referring to the screen illustrated in FIG. 6 displayed by the web browser 201.

Herein, the web browser 201 can detect that the synchronization processing is completed in step S715 and the like. Thus, the user may be notified of the completion of the synchronization processing by a notification method similar to that illustrated in FIG. 16. More specifically, the completion notification can be provided by displaying a message “synchronization processing of aaa.com is completed” on a message area.

In the first exemplary embodiment, the website not having the change notification function is determined to be in the “in communication” state and to be unavailable offline when the website is accessing the browser storage. Furthermore, such a website is determined to be in the “communication completed” state and available offline when the website is not accessing the browser storage.

As a feature of the web storage as a type of a storage area included in the browser storage, two types of area known as local storage and session storage are available. Data stored in the local storage remains in the storage area even when the web browser is closed, and thus can be used again next time the web browser is started. On the other hand, data stored in the session storage is erased when the web browser is closed.

Hereinafter, temporary storage areas such as the session storage are collectively referred to as a temporary area. In the present invention, data required for the operation of the web application in the offline state is not stored in such a temporary area.

In a second exemplary embodiment, the offline availability of the website that does not have the change notification function is more accurately determined by using the feature of the temporary area. The difference from the first exemplary embodiment is described below.

<Processing Executed when Access to Browser Storage Starts>

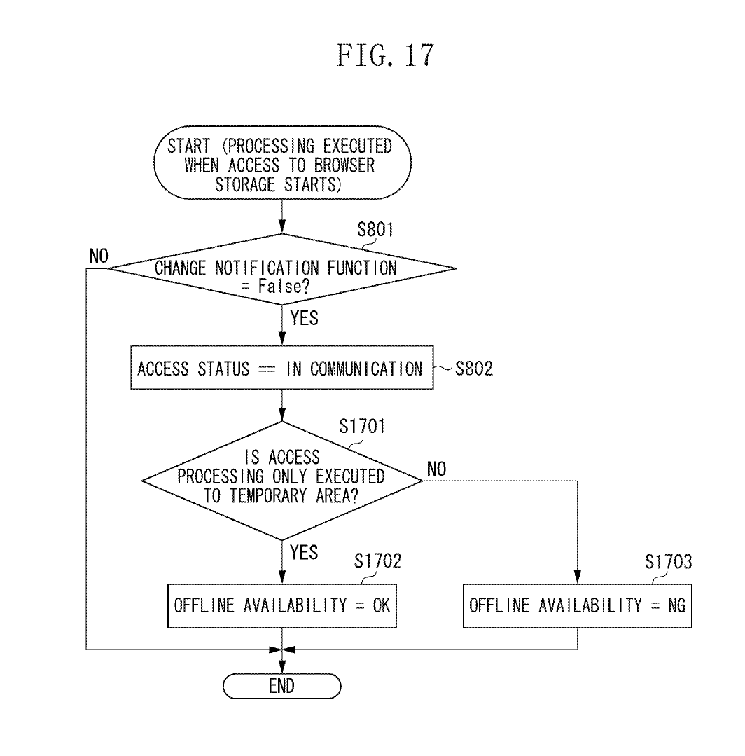

FIG. 17 is a flowchart illustrating processing executed when access processing to the browser storage starts, in the present exemplary embodiment. This processing is an extended version of the processing in the first exemplary embodiment illustrated in FIG. 8, and additionally includes processing of determining whether the access is made to the temporary area only. The web browser 201 generates an instance of the interpreter 206 and executes this processing.

In step S1701, the interpreter 206 determines whether the access processing is executed by the website as the access origin to the temporary area only. When the interpreter 206 determines that the access processing is executed to the temporary area only (YES in step S1701), the processing proceeds to step S1702. On the other hand, when determined otherwise (NO in step S1701), the processing proceeds to step S1703.

In step S1702, the interpreter 206 sets the offline availability information 505 of the website as the access origin to “OK”, and the processing is terminated. The website is accessing the browser storage and thus the access status is determined to be the “in communication” state, and the offline availability is determined to be “OK” because the website is accessing the temporary area only. On the other hand, in step S1703, the interpreter 206 sets the offline availability information 505 of the website as the access origin to “NG”, and the processing is terminated.

<Processing Executed when Access to Browser Storage Ends>

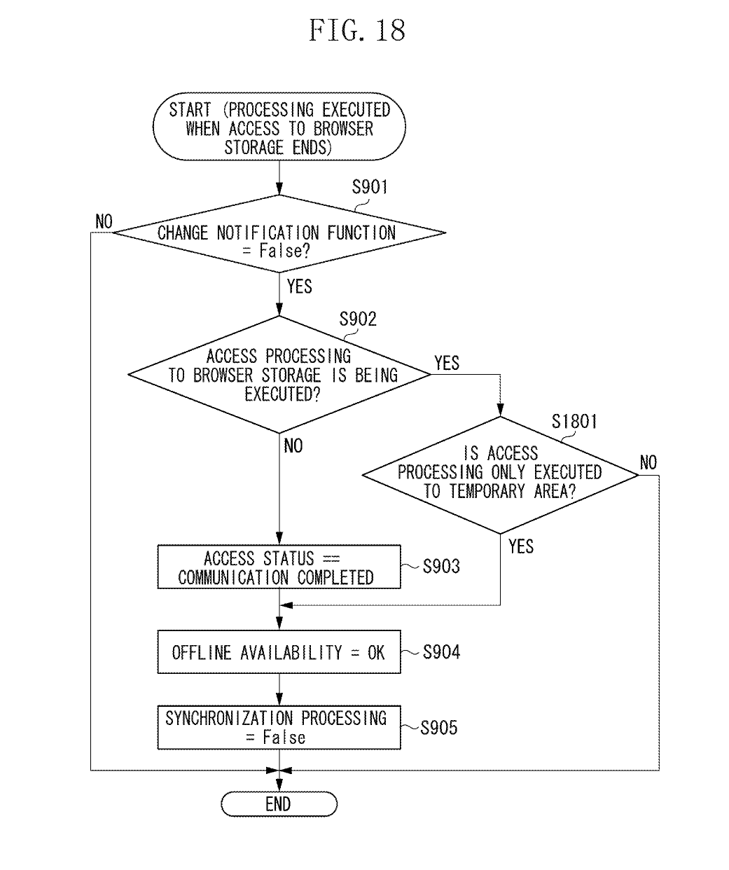

FIG. 18 is a flowchart illustrating an example of a procedure of processing executed when the access to the browser storage ends in the present exemplary embodiment. This processing is an extended version of the processing in the first exemplary embodiment illustrated in FIG. 9, and additionally includes processing of determining whether the access is made to the temporary area only. The web browser 201 generates an instance of the interpreter 206, and executes this processing.

When the result of the determination in step S902 is YES, in step S1801, the interpreter 206 determines whether the website is accessing the temporary area only. When the interpreter 206 determines that the access processing is executed to the temporary area only (YES in step S1801), the processing proceeds to step S904. On the other hand, when determined otherwise (NO in step S1801), the processing is terminated. Herein, the offline availability is determined to be “OK” because the access is made to the temporary area only as in the processing illustrated in FIG. 17.

A web browser according to the present invention, capable of managing the progress of the communications of the websites having the change notification function and the website not having the change notification function, has been described with the exemplary embodiments described above.

However, as a modification of the present invention, a web browser having the management function for either of the websites having the change notification function and the website not having the change notification function can be implemented. As a specific example of such a web browser, the change notification function of the web application is not taken into consideration, and the processing in FIG. 8 and FIG. 9 as the management function for the website is implemented. In such a case, the information managed in step S503 in FIG. 5 and a partial function and processing such as that in step S801 in FIG. 8 and step S901 in FIG. 9 can be omitted, and only the minimum required processing may be implemented. On the other hand, the change notification function of the web application is taken into consideration, and only the function relating to the processing illustrated in FIG. 7 can be implemented by the web browser.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-112625, filed May 30, 2014 which is hereby incorporated by reference herein in its entirety.

What is claimed is:

1. An information terminal, on which a web browser having a function of storing, for each web application, data specified by a web application accessed by the web browser in a browser storage, operates, the information terminal comprising:
a determination unit configured to determine a state of a communication of a web application for using the browser storage; and
a display control unit configured to display information relating to use of the web application in accordance with determination made by the determination unit.

2. The information terminal according to claim 1, wherein the display control unit is configured to display, as the information relating to use of the web application, information indicating whether the web application is usable in an offline state where the information terminal is not connected to a network.

3. The information terminal according to claim 1, wherein the display control unit is configured to display, as the information relating to use of the web application, information with which a user is able to confirm that synchronization processing of data in the browser storage with data in a web server that provides the web application has been completed.

4. The information terminal according to claim 1, further comprising:
a setting unit configured to make a setting relating to determination of whether to continue the communication for using the browser storage in a case where an instruction to close the web browser is detected; and
a control unit configured to control closing of the web browser in accordance with the setting performed by the setting unit.

5. The information terminal according to claim 4, wherein the control unit is configured to perform control in such a manner that the web browser is closed after the communication of the web application for using the browser storage is completed, in a case where the setting unit has made a setting for continuing the communication of the web application for using the browser storage even in a case where the instruction to close the web browser is detected.

6. The information terminal according to claim 4, wherein the setting unit is configured to set, as a communication to be continued in a case where the instruction to close the web browser is detected, synchronization processing using data in the browser storage.

7. The information terminal according to claim 4, wherein the setting unit is configured to set information relating to a web application for which the communication is to be continued in a case where the instruction to close the web browser is detected.

8. An information terminal, on which a web browser having a function of storing, for each web application, data specified by a web application accessed by the web browser in a browser storage, operates, the information terminal comprising:
a determination unit configured to determine a state of a communication with a web application; and
a display control unit configured to display information relating to use of the web application in accordance with determination made by the determination unit,
wherein the display control unit is configured to display, as the information relating to use of the web application, information indicating whether the web application is usable in an offline state where the information terminal is not connected to a network.

9. The information terminal according to claim 8, wherein the determination unit is configured to determine the state of the communication based on a notification from the web application.

10. The information terminal according to claim 9, wherein the notification from the web application includes a notification indicating that a communication for storing the data specified by the web application in the browser storage starts, and a notification indicating that the communication for storing the data specified by the web application in the browser storage is completed.

11. The information terminal according to claim 10, wherein the display control unit is configured to display, as the information relating to use of the web application, information indicating that the web application is usable in the offline state, in accordance with determination made by the determination unit based on the notification indicating that the communication for the storing is completed.

12. The information terminal according to claim 9, wherein the notification from the web application includes a notification indicating that a communication for synchronization processing of data in the browser storage with data in a web server that provides the web application starts, and a notification indicating that the communication for synchronization processing of data in the browser storage with the data in the web server that provides the web application is completed.

13. The information terminal according to claim 12, wherein the display control unit is configured to display, as the information relating to use of the web application, information with which a user is able to confirm that the synchronization processing of data in the browser storage with the data in the web server that provides the web application has been completed, in accordance with determination made by the determination unit based on the notification indicating that the communication for the synchronization processing is completed.

14. The information terminal according to claim 9,
wherein the notification from the web application includes a notification indicating that the web application is usable in the offline state, and
wherein the display control unit is configured to display, as the information relating to use of the web application, information indicating that the web application is usable in the offline state, in accordance with determination made by the determination unit based on the notification indicating that the web application is usable in the offline state.

15. The information terminal according to claim 8, wherein the determination unit is configured to, in order to determine the state of the communication of the web application for using the browser storage, detect access to the browser storage by the web application and end of the access.

16. The information terminal according to claim 15, wherein the display control unit is configured to display, as the information relating to use of the web application, information indicating that the web application is usable in the offline state, in accordance with determination made by the determination unit in a case where the determination unit detects the end of the access to the browser storage by the web application.

17. The information terminal according to claim 15,
wherein the browser storage includes a session storage from which data is erased in a case where the web browser is closed and an area from which the data is not erased in the case where the web browser is closed, and
wherein the display control unit is configured to display, as the information relating to use of the web application, information indicating that the web application is usable in the offline state, in accordance with the determination, made by the determination unit, that the web application is accessing only to the session storage in the browser storage.

18. The information terminal according to claim 8, wherein the display control unit is configured to display a warning indicating that the web application is possibly not usable in the offline state in a case where access to the browser storage by the web application is interrupted by closing of the web browser or transition of the information terminal to the offline state.

19. A method for controlling a web browser having a function of storing, for each web application, data specified by a web application accessed by the web browser in a browser storage of an information terminal on which the web browser operates, the method comprising:
determining a state of a communication of a web application for using the browser storage; and
displaying information relating to use of the web application in accordance with the determining.

20. The method according to claim 19, wherein in the displaying, as the information relating to use of the web application, information indicating whether the web application is usable in an offline state where the information terminal is not connected to a network is displayed.

21. The method according to claim 19, wherein in the displaying, as the information relating to use of the web application, information with which a user is able to confirm that synchronization processing of data in the browser storage with data in a web server that provides the web application has been completed is displayed.

22. The method according to claim 19, further comprising:
making a setting relating to determination of whether to continue the communication for using the browser storage in a case where an instruction to close the web browser is detected; and
controlling closing of the web browser in accordance with the setting.

23. The method according to claim 22, wherein in the controlling, control is performed in such a manner that the web browser is closed after the communication of the web application for using the web browser is completed, in a case where a setting for continuing the communication of the web application for using the browser storage even in a case where the instruction to close the web browser is detected is made.

24. The method according to claim 22, wherein in the setting, as a communication to be continued in a case where the instruction to close the web browser is detected, synchronization processing using data in the browser storage is set.

25. The method according to claim 22, wherein in the setting, information relating to a web application for which the communication is to be continued in a case where the instruction to close the web browser is detected is set.

26. A method for controlling a web browser having a function of storing, for each web application, data specified by a web application accessed by the web browser in a browser storage of an information terminal on which the web browser operates, the method comprising:
determining a state of a communication with a web application; and
displaying information relating to use of the web application in accordance with the determining,
wherein in the displaying, as the information relating to use of the web application, information indicating whether the web application is usable in an offline state where the information terminal is not connected to a network is displayed.

27. The method according to claim 26, wherein in the determining, the state of the communication is determined based on a notification from the web application.

28. The method according to claim 27, wherein the notification from the web application includes a notification indicating that a communication for storing the data specified by the web application in the browser storage starts, and a notification indicating that the communication for storing the data specified by the web application in the browser storage is completed.

29. The method according to claim 28, wherein in the displaying, as the information relating to use of the web application, information indicating that the web application is usable in the offline state is displayed, in accordance with the determining based on the notification indicating that the communication for the storing is completed.

30. The method according to claim 27, wherein the notification from the web application includes a notification indicating that a communication for synchronization processing of data in the browser storage with data in a web server that provides the web application starts, and a notification indicating that the communication for synchronization processing of data in the browser storage with the data in the web server that provides the web application is completed.

31. The method according to claim 30, wherein in the displaying, as the information relating to use of the web application, information with which a user is able to confirm that the synchronization processing of data in the browser storage with the data in the web server that provides the web application has been completed is displayed, in accordance with the determining based on the notification indicating that the communication for the synchronization processing is completed.

32. The method according to claim 27,
wherein the notification from the web application includes a notification indicating that the web application is usable in the offline state, and
wherein in the displaying, as the information relating to use of the web application, information indicating that the web application is usable in the offline state is displayed, in accordance with the determining based on the notification indicating that the web application is usable in the offline state.

33. The method according to claim 26, wherein, to determine the state of the communication of the web application for using the browser storage, in the determining, access to the browser storage by the web application and end of the access are detected.

34. The method according to claim 33, wherein in the displaying, as the information relating to use of the web application, information indicating that the web application is usable in the offline state is displayed, in accordance with determination made in a case where the end of the access to the browser storage by the web application is detected.

35. The method according to claim 33,
wherein the browser storage includes a session storage from which data is erased in a case where the web browser is closed and an area from which the data is not erased in the case where the web browser is closed, and
in the displaying, as the information relating to use of the web application, information indicating that the web application is usable in the offline state is displayed, in accordance with determination, made in the determining, that the web application is accessing only to the session storage in the browser storage.

36. The method according to claim 26, wherein in the displaying, a warning indicating that the web application is possibly not usable in the offline state in a case where access to the browser storage by the web application is interrupted by closing of the web browser or transition of the information terminal to an offline state, is displayed.

37. A computer readable storage medium storing a computer program for causing a computer to execute a method for a web browser having a function to store, for each web application, data specified by a web application accessed by the web browser in a storage of an information terminal on which the web browser operates, the method comprising:
determining a state of a communication of a web application for using the browser storage; and
displaying information relating to use of the web application in accordance with the determining.

38. A computer readable storage medium storing a computer program for causing a computer to execute a method for a web browser having a function to store, for each web application, data specified by a web application accessed by the web browser in a storage of an information terminal on which the web browser operates, the method comprising:
determining a state of a communication with a web application; and
displaying information relating to use of the web application in accordance with the determining,
wherein in the displaying, as the information relating to use of the web application, information indicating whether the web application is usable in an offline state where the information terminal is not connected to a network is displayed.
